(19) United States
(12) Patent Application Publication
(10) Pub. No.: US 2022/0215332 A1
(43) Pub. Date: Jul. 7, 2022

(54) USING MACHINE LEARNING TO PREDICT IMPACTS TO A SUPPLY CHAIN BY ANALYZING CURRENT EVENTS

(71) Applicant: Capital One Services, LLC, McLean, VA (US)

(72) Inventors: Jennifer Kwok, New York, NY (US); Abdelkader Benkreira, New York, NY (US); Viraj Chaudhary, Katy, TX (US)

(21) Appl. No.: 17/140,679

(22) Filed: Jan. 4, 2021

(51) Int. Cl. G06Q 10/08; G06N 20/00; G06N 5/04

(52) U.S. Cl. CPC G06Q 10/087; G06N 5/04; G06N 20/00

(57) ABSTRACT

Systems as described herein may predict impacts to a supply chain by analyzing current events. A merchant perdition server may retrieve news using a scraping algorithm, parse the news to identify keywords, and determine one or more industries that will be impacted by the news. The merchant perdition server may retrieve enterprise merchant intelligence information including a merchant category for each of small business merchants. The merchant perdition server may determine, based on a first industry of the one or more industries matching a first merchant category, a first small business merchant and one or more products that will be impacted by the news. Accordingly, the merchant perdition server may send to the first small business merchant, an alert indicating shortages of the one or more products.

### FIELD OF USE

Aspects of the disclosure relate generally to big data and more specifically to the processing and management of big data.

### BACKGROUND

In an electronic payment processing network, a financial institution may receive transaction data originated from a variety of merchants, including small business merchants. The merchants may be focused on day-to-day operations and lack resources to plan ahead for unexpected events, such as a pandemic, a government lockdown, a natural disaster, a political upheaval, or an economic downturn, which may impact a supply chain. As a result, such merchants may have to change their spending behaviors ad hoc in response to shortages of goods. Conventional financial systems may fail to recognize the reasons behind these changes of spending behaviors, thereby limiting their ability to provide insights to the crediting decision process and fraud detection logic to facilitate their customers to weather upcoming uncertainties.

Aspects described herein may address these and other problems, and generally improve the quality, efficiency, and speed of processing big data to offer insights into crediting decisions and fraud logic so that business customers may make informed decisions based on a prediction of shortages of relevant goods.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for predicting disruptions in supply chains. These disruptions may result in shortages of goods, which may impact crediting decisions and fraud determinations related to small businesses. A merchant prediction system may retrieve, by a first device and using a scraping algorithm, news associated with a geographic area. The merchant prediction system may parse the news to identify keywords including at least one of topic keywords or volatility triggering keywords. The merchant prediction system may determine, based on one or more keywords, one or more industries associated with the geographic area that will be impacted by the news. The merchant prediction system may retrieve enterprise merchant intelligence information associated with one or more small business merchants, where the enterprise merchant intelligence information comprises a merchant category for each of the one or more small business merchants. Based on a first industry of the one or more industries matching a first merchant category, the merchant prediction system may determine a first small business merchant that will be impacted by the news using a first machine learning model. The merchant prediction system may determine one or more products associated with the first small business merchant that will be impacted by the news using a second machine learning model. The merchant prediction system may send to the first small business merchant on a second device, an alert indicating shortages of one or more products.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system for predicting impacts to a supply chain by analyzing current events in which one or more aspects described herein may be implemented;

FIG. 2 shows an example computing device in accordance with one or more aspects described herein;

FIG. 3 shows a flow chart of a process for predicting impacts to a supply chain by analyzing current events according to one or more aspects of the disclosure; and

FIG. 4 shows a flow chart of a process for predicting shortages of goods on related products according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for predicting disruptions in supply chains, which may result in shortages of goods. Predicted supply chain disruptions may be used to inform credit decisions and fraud determinations for merchants (e.g., small business entities). The merchant prediction system may train a first machine learning model to identify small business merchants associated with a first merchant category and train a second machine learning model using transaction records to recognize recurring purchases, including, for example, the recurring purchases of supplies, products, or other goods. The merchant prediction system may analyze historical transactions of the first small business merchant, where the historical transactions comprise one or more recurring purchases. Conversely, the merchant prediction system may determine one or more products based on the one or more recurring purchases in the historical transactions.

The merchant prediction system as described herein allows for determining a first product associated with a first small business merchant that is impacted by an event, determining a second product associated with the first small business merchant and correlated with the first product that is impacted by the event; and sending an alert indicating the shortage of a product associated with the first product and the second product.

In many aspects, the merchant prediction system may collect news from a first format (e.g. unstructured format), convert the news to a common format—such as JSON or XML format, and analyze the news to determine one or more keywords. The merchant prediction system may automatically retrieve the news from online public sources or a third party Application Programing Interface (API). The merchant prediction system may parse the news using natural language processing (NLP) and determine the one or more keywords using term frequency-inverse document frequency (TFIDF) analysis.

In many aspects, the merchant prediction system may analyze credit history of the first small business merchant. The merchant prediction system may compare a current credit limit to a historic credit limit, and increase the current credit limit based on a prediction that the first small business merchant will be stockpiling the one or more products based on a disruption to a supply chain. The merchant prediction system may compare current spending behavior with past spending behavior, and adjust a fraud logic based on a prediction that the first small business merchant will be stockpiling the one or more products. The merchant prediction system may send, to the first small business merchant, a recommendation to stockpile the one or more products.

### Merchant Prediction Systems

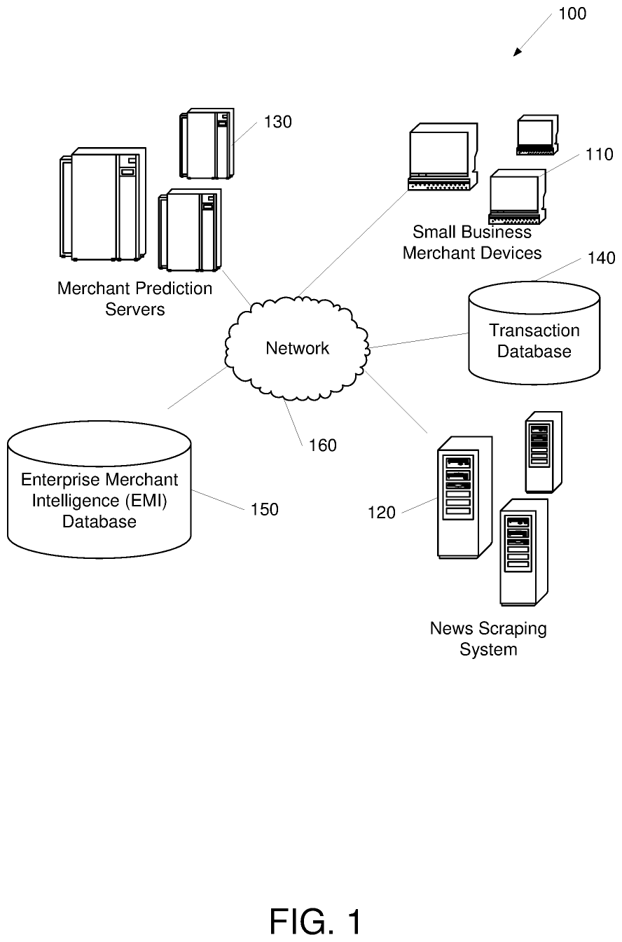

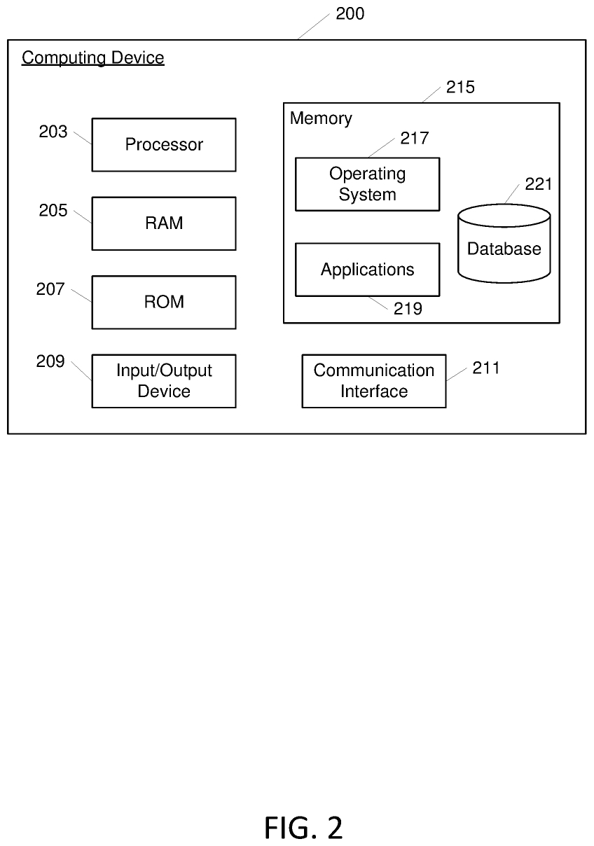

FIG. 1 shows a merchant prediction system 100. The merchant prediction system 100 may include at least one small business merchant devices 110, at least one news scraping system 120, at least one merchant prediction servers 130, at least one transaction record database 140, and/or at least one enterprise merchant intelligence (EMI) database 150 via a network 160. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 2.

Small business merchant devices 110 may submit transaction information related to a transaction such as a merchant identifier, a transaction amount, merchant information and a transaction timestamp, and/or receive an alert indicating predicted product shortages or a recommendation to stockpile certain products based on the predicted shortages. Small business merchant devices 130 may send requests for authorization for recurrent transactions for purchase of goods that are used to make the end products.

News scraping system 120 may collect, parse, and/or store events, such as news, weather, and traffic related to a geographic location. The geographic location may be associated with a location of a small business merchants or a supplier that may cause disruption to a supply chain. The news may be stored as unstructured data from various news sources, which may include books, journals, documents, metadata, health records, audio, video, analog data, images, files, or the like. The news may also be stored as unstructured text, such as the body of an e-mail message, Web page, or word-processor document. For example, news scraping system 120 may extract content and/or data from a news website automatically using a bot, web scraper, etc. News scraping system 120 may access the news website using the Hypertext Transfer Protocol (HTTP), or through a web browser. News scraping system 120 may obtain a data dump from the news sources and store the data in a corpus database (not shown in FIG. 1). News scraping system 120 may copy and/or collect unstructured data from the web, convert the news data into a common format, such as a JavaScript Object Notation (JSON) format or an Extensible Markup Language (XML) format. News scraping system 120 may store the news data in the corpus database for later retrieval and/or analysis.

Merchant prediction servers 130 may retrieve the news data from the corpus database, and parse the news data to identify keywords. News scraping system 120 may be a component of merchant prediction servers 130 or may be a system independent from merchant prediction servers 130 as illustrated in FIG. 1. Merchant prediction servers 130 may identify volatility triggering words in the news that may be related to events, such as, a pandemic, a government lockdown, a natural disaster, a riot, an economic downturn, or a new regulation that may impact the availability of goods or cause a disruption to a supply chain. For example, a new regulation to cause a closure of a bridge in the vicinity of a small business merchant store for a prolonged period of time may impact transportation of goods to the store and cause a disruption to the supply chain that may lead to shortages of goods in the future. A hurricane causing a disruption to a specialty vanilla bean production may impact a small business merchant such as an ice cream shop that uses the specialty vanilla bean in making its final product. Merchant prediction servers 130 may identify volatility triggering words that may be related to, for example, Red Cross, or National Guard that may be related to a natural disaster leading to a disruption in a supply chain, which may cause shortages of certain goods associated with a merchant's goods and/or services.

Merchant prediction servers 130 may also identify topic words in the news. A topic may be an abstract concept used to measure how a piece of news belongs to different categories. For example, a news article on wildfire may contain topic keywords such as “lumber” or “construction.” Merchant prediction servers 130 may use a topic model, for example, a statistical model to discover the abstract topics that occur in a collection of documents. Topic modeling may be a text-mining tool for the discovery of hidden semantic structures in a text body. For example, if a document is about a particular topic, certain words may appear in the document more frequently, such as “lumber” or “construction.” A document may contain multiple topics in different proportions, such as 70% “lumber,” 20% “construction,” and/or 10% “paper.” The topics produced by topic modeling techniques may be clusters of similar words. A topic model may be a mathematical framework, which may allow a set of documents to be examined and discovered, for example, based on the statistics of the words in each document, the topics in the document and the proportion of each topic. Due to the large amount of news data that merchant prediction servers 130 may have to process, the topic models may be helpful to organize the news data and/or offer insights to understand large collections of unstructured text bodies.

Merchant prediction servers 130 may filter out certain stop words from the news data, such as “that's, the, are, to” to adjust for the fact that some words may appear more frequently in general. Merchant prediction servers 130 may filter the stop words using, for example, term frequency-inverse document frequency (TFIDF), which may be a numerical statistic model that may reflect how important a word is to a document in a collection or corpus.

Merchant prediction servers 130 may determine one or more industries associated with the geographic area that will be impacted by the news, based on one or more keywords. For example, merchant prediction servers 130 may detect a news spike reporting on a wildfire in Colorado, and determine the industries that may be impacted by the news based on topic keywords, such as “fire,” “forest,” “lumber,” and/or “construction.”

Transaction database 140 may store transaction records related to transactions previously conducted by users in transaction streams from a plurality of small business merchants. Transaction database 140 may receive a request from merchant prediction servers 130 and retrieve the corresponding transaction records in the transaction streams. The transaction records may each contain an account identifier, a transaction amount, a transaction time, a merchant identifier, etc. Transaction database 140 may store transaction records associated with recurrent payments from a small business merchant indicating a pattern that the small business merchant re-stocks its inventory periodically.

Enterprise merchant intelligence (EMI) database 150 may store merchant records related to small business merchants. Enterprise merchant intelligence database 150 may be a merchant database that stores enterprise merchant intelligence records, which may in turn include a merchant identifier, a friendly merchant name, a zip code, a physical address, a phone number, an email or other contact information of the merchants, or a merchant category code (MCC). A MCC may be a four-digit number listed in ISO 18245 for retail financial services and used to classify a business by the types of goods or services it provides. MCCs may be assigned either by merchant type (e.g., one for hotels, one for office supply stores, etc.) or by merchant name. For example, Wal-Mart Supercenters are classified as MCC No. 5411, “Grocery stores/supermarkets/bakeries,” while standard Wal-Marts (without groceries) are classified as 5310, “discount stores/warehouse/wholesale.” The merchant records may be collected from public resources or merchant reported records.

In a variety of embodiments, a financial organization may build a proprietary EMI database 150, for example, based on an aggregation of transaction records in transaction database 150. As a transaction arrives from a transaction stream, the corresponding transaction record may be processed, cleaned, and/or enhanced with a variety of services. For example, when a financial institution receives the transaction information in a transaction stream, the transaction information may be in the form of a line of data that offers limited information about the transaction, with each piece of information appearing in certain locations within the line of data. The merchant identifier may appear in a specific location and may include 8-10 characters in the abbreviated form, which may not be readily recognizable as a meaningful merchant name, particularly for small business merchants. The financial institution may process this abbreviated merchant identifier and convert it into a meaningful merchant name in a human readable format, and store it in EMI database 150.

In a variety of embodiments, a financial institution may use a third party API to gather merchant information, such as a merchant address or contact information, to be stored in EMI database 150. In a variety of embodiments, a financial organization may maintain more static merchant information, such as a merchant identifier and MCC, in its proprietary EMI database 150; and a financial institution may use the third party API to get merchant address, merchant social media handle, or other merchant information that may change over time. The merchant information may be gathered in a text format or unstructured format and later converted into a common format.

Merchant prediction servers 130 may retrieve enterprise merchant intelligence information associated with one or more small business merchants, wherein the enterprise merchant intelligence information may comprise a merchant category for each of the small business merchants. As previously noted, merchant prediction servers 130 may also determine one or more industries that will be impacted by the news. Based on a determination that one or more merchant category codes matches an industry impacted by the news, merchant prediction servers 130 may use a first machine learning model to determine a small business merchant that will be impacted by the news. Merchant prediction servers 130 may identify small business merchants who have one or more recurring purchases in a merchant category impacted by the news. Merchant prediction servers 130 may use a second machine learning model to determine one or more products associated with the first small business merchant that will be impacted by the news.

Merchant prediction servers 130 may send, to small business merchant devices 110, an alert indicating shortages of the one or more products. Merchant prediction servers 130 may suggest to the small business merchants to repurchase the goods now rather than at a future time. Merchant prediction servers 130 may also increase credit limit and/or adjust fraud logic to allow transactions to go through with the understanding that the small business merchants may change the spending behavior in response to the alert.

Small business merchant devices 110, news scraping system 120, merchant prediction servers 130, transaction record database 140, and/or EMI database 150 may be associated with a particular authentication session. Merchant prediction servers 130 may receive, process, and/or store a variety of transaction records and enterprise merchant intelligence information, and/or receive transaction records with small business merchant devices 110 as described herein. However, it should be noted that any device in merchant prediction system 100 may perform any of the processes and/or store any data as described herein. Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. The network 180 may include a local area network (LAN), a wide area network (WAN), a wireless telecommunications network, and/or any other communication network or combination thereof.

The data transferred to and from various computing devices in merchant prediction system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the data sharing system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in the item level data prediction system 100 in front of one or more computing devices such that any external devices may communicate directly with the specialized hardware.

### Computing Devices

Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. Memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

### Predicting Impacts to a Supply Chain by Analyzing Current Events

The merchant prediction system may scrape news sources and EMI databases to collect business intelligence related to tens of thousands of small business merchants located in numerous geographic locations. The merchant prediction system may use a machine learning model to identify relevant merchants that may be impacted by the news and provide options to the merchants on how to address the predicted shortages of goods.

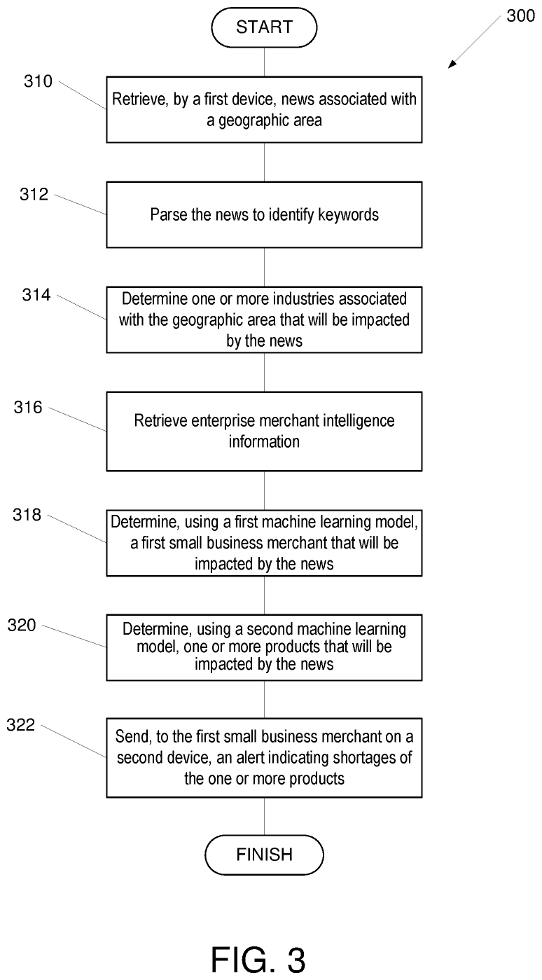

FIG. 3 shows a flow chart of a process for predicting impacts to a supply chain by analyzing current events according to one or more aspects of the disclosure. Some or all of the steps of process 300 may be performed using one or more computing devices as described herein.

At step 310, a first device may retrieve news associated with a geographic area, for example, using a scraping algorithm. For example, a news scraping system and/or merchant prediction server may extract content and/or data from a news website automatically using a scraping algorithm via a bot, web scraper, or an equivalent automated tool. The news scraping system and/or merchant prediction server may access the news website using any suitable internet protocol, such as HTTP, or through a web browser. The news scraping system and/or merchant prediction server may obtain a data dump from the news sources and/or store the data in a corpus database or a dump file.

In a variety of embodiments, news may be collected as unstructured data format or text format, and converted into a common format, such as a JSON format or an XML format.

In a variety of embodiments, news collected using the scraping algorithm in a data stream may be processed on the fly (e.g., in real-time). The collected news may also be processed in a batch manner. For example, news transcripts may be collected periodically or the unstructured news data may be dumped periodically, such as once per hour, once per 10 minutes, or once per day. News data in the text format may be pre-processed, using a random sampling to take chunks of transcripts to look for similarities among different batches to eliminate duplicated data. The news data may be dumped after a verification of non-duplicated data to produce a lightweight data payload.

At step 312, retrieved news may be parsed to identify keywords. The keywords may comprise at least one of topic keywords, volatility triggering keywords, or any other suitable keyword. Merchant prediction servers may use natural language processing (NLP) to parse the news and identify the keywords. The volatility triggering words may be related to events, such as a pandemic, a government lockdown, a natural disaster, a riot, an economic downturn, or a new regulation, that may impact the availability of goods or cause shortages of goods. Volatility triggering words may include words that may not be intuitively identified, such as Red Cross or National Guard that may also be related to a natural disaster leading to shortages of goods. For example, there may be an increase in news reporting that the National Guard responds to a flood in the coastal area of New Jersey. There also may be news reporting that floods in the state of New Jersey may cause tree damage that impacts the lumber production in the state. The flood may also cause road closures in certain areas of New Jersey that may impact the transportation of lumber from outside the state. In this example, the merchant prediction server may identify volatility triggering words such as “flood,” “road closure,” “New Jersey,” and “National Guard.”

Merchant prediction servers may also identify topic keywords in the news. A topic may be an abstract concept used to measure how a document or a news article belongs to different categories. Merchant prediction servers may filter out certain stop words from the news data, using TFIDF model. The retrieved news may be pre-processed to remove those stop words that do not add much meaning to the sentences, such as “at,” “the,” “is,” “which,” etc.

Merchant prediction servers may use a topic model to discover the abstract topics that occur in a collection of news documents. The topic model may include a generalized probabilistic latent semantic analysis (PLSA) model or a latent Dirichlet allocation (LDA) model. For example, the flood in New Jersey may impact the production and/or transportation of lumber and other construction materials. Merchant prediction servers may identify the topic keywords such as “lumber” and “construction.”

At step 314, one or more industries associated with the geographic area that will be impacted by the news may be determined based on the keywords. Merchant prediction servers may determine that certain topic keywords may correspond to types of industries, while other topic keywords may not correspond to types of industries. For example, merchant prediction servers may determine that topic keywords “lumber” and “construction” may correspond to different types of industries that may be impacted by the news reporting the flood in New Jersey.

At step 316, enterprise merchant intelligence information associated with one or more small business merchants may be retrieved, and the enterprise merchant intelligence information may include a merchant category for each of small business merchants. Enterprise merchant intelligence information may be retrieved from a database, such as EMI database 150, where a merchant record in the EMI database may contain a small business merchant identifier, a friendly or human readable merchant name, merchant contact information, and/or MCC that the merchant belongs to.

At step 318, a first machine learning model may be used to determine a first small business merchant that will be impacted by the event/news. The determination may be based on a first industry of the one or more industries matching a first merchant category from the enterprise merchant intelligence information. The first machine learning model may be a supervised machine learning model, or an unsupervised machine learning model. Merchant prediction servers may identify that keywords “lumber” and “construction” match with, for example, 30 MCCs in the EMI database, including “lumber,” “building materials,” “construction,” “flooring,” “carpentry” and “furniture.”

The first machine learning model may use volatility trigger words, topic keywords, merchant category code (MCC), and the like as inputs to the first machine learning model. The first machine learning model may use additional inputs, such as the geographic location, whether the small business merchant is an online store, or a brick and mortar store. In this regard, an online store with a warehouse located outside the state may not be impacted by a flood in New Jersey, while a local store in the coastal area of New Jersey may be impacted by the flood. The first machine learning model may also use inputs, such as a time period—while the flood may impact local lumber supply in the next six months, a regulation change may impact the supply of goods starting in the second quarter of 2022.

Merchant records in the EMI database and/or transaction records in the transaction database may be used as training data that is fed into the first machine learning model. The transaction records may each contain information related to previously conducted transactions, such as an account identifier, a transaction amount, a transaction time, and/or a merchant identifier. The transaction records may store transaction records associated with recurrent payment from a small business merchant indicating a pattern of how the small business merchant restock its inventory periodically. The merchant records may include small business merchant information such as a merchant identifier, a friendly merchant name, a zip code, a physical address, a phone number, an email or other contact information of the merchants, or a merchant category code (MCC). The first machine model may also determine a confidence score to indicate the degree at which the small business merchant may be impacted by the news. The first machine may be tuned based on the confidence score reaching a threshold value. The first machine learning model may be trained to identify small business merchants associated with a merchant category code matching the keywords.

Based on a match between the keywords and MCCs of a set of merchants in the EMI database and their transaction records, the first machine learning model may determine the relevant small business merchants that may be impacted by the news. For example, among the 30 MCCs impacted by the flood in New Jersey, the first machine learning model may determine a first small business builder located within 20 miles of the flooding area and the builder may have recurrent purchases of lumber that may be impacted by the flood. The first machine learning model may determine a second small business customer, a local school, who has recently been granted a construction loan for a school expansion project that may be impacted by the lumber shortage.

At step 320, a second machine learning model may determine one or more products associated with the first small business merchant. As noted above, the one or more products may be impacted by current events/news. The second machine learning model may be a supervised machine learning model, or an unsupervised machine learning model. The second machine learning model may use the relevant merchants determined by the first machine learning model as an input. Based on the records in the transaction database and EMI database, data over a time series may be generated, such as an aggregated spending per merchant category code, which may be also used as input to the second machine learning model. The previous transaction records of the relevant merchants, particularly transactions related to recurrent purchases, may be used as training data for the second machine learning model. For example, the small business builder may have monthly recurring purchases of lumber that may be impacted by the flood and there may be a projected lumber shortage in New Jersey in the near future.

At step 322, an alert may be sent to the first small business merchant on a second device indicating a possible disruption in one or more supply chains, including one or more shortages of one or more products. Merchant prediction servers may send an alert to a small business merchant device to recommend stockpiling the one or more products, or to stockpile a larger quantity of goods than in its regular purchases. Merchant prediction servers may also automatically increase the credit limits to facilitate the recommended purchases. For example, merchant prediction servers may analyze credit history of the small business builder. Merchant prediction servers may compare a current credit limit of the small business builder to a historic credit limit, and increase the current credit limit based on a prediction that the small business builder may be stockpiling the one or more products based on the alert. In some examples, the increased credit limit may be for a predetermined amount of time.

Merchant prediction servers may adjust the fraud logic with an expectation that the small business merchants may act on the alerts and/or change their spending behaviors. For example, merchant prediction servers may analyze the spending history of the small business builder, comparing current spending behavior with past spending behavior, and adjust a fraud logic based on a prediction that the small business builder may be stockpiling one or more products based on the alert. In another example, merchant prediction servers may change the terms of the construction loan to the local school to allow additional cash advancement for the payment of building materials to accommodate the projected price increase.

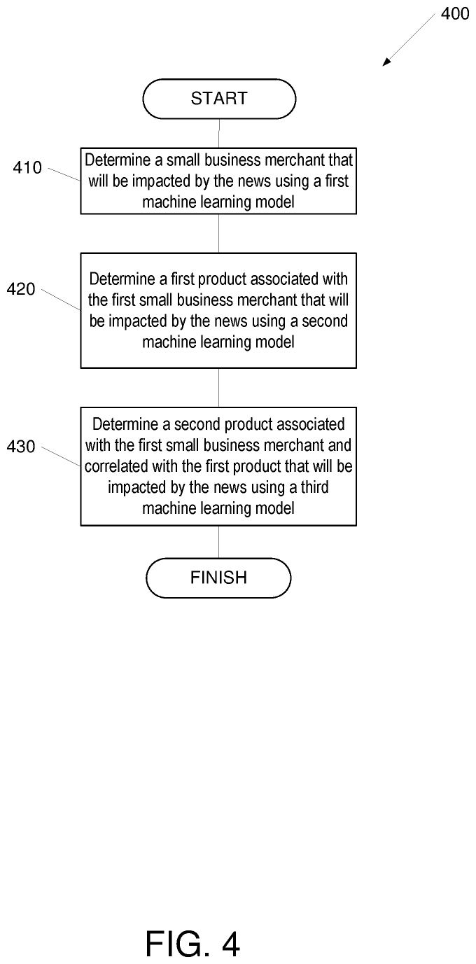

FIG. 4 shows a flow chart of a process of predicting shortages of goods on related products according to one or more aspects of the disclosure. Some or all of the steps of process 400 may be performed using one or more computing devices as described herein.

At step 410, a first machine learning model may be used to determine a small business merchant that will be impacted by the news. As described, the first machine learning model may determine the small business merchant based on previous transaction records and/or enterprise merchant intelligence information. As a transaction arrives at a transaction stream, the transaction record may include the transaction date and a general geographic location, such as a city or zip code where the merchant resides. To make more precise predictions, merchant prediction servers may use enterprise merchant intelligence information to determine the relevancy of the news to the small business merchant. The enterprise merchant intelligence information may include the detailed address, such as a street address of the merchant. For example, if the news indicates a bridge closure, merchant prediction servers may need to get the street address of the small business merchant to determine whether the merchant may be impacted by the closure.

At step 420, a second machine learning model may be used to determine a first product associated with the first small business merchant that will be impacted by the news. As described, the second machine learning model may determine the first product that may be impacted by the news based on an output of the first machine learning model and aggregated spending per MCC over a period of time. The second machine model may determine that there are recurring purchases in the MCC that are associated with the small business merchant, and identify the first product that may be impacted by the news. The second machine model may determine a plurality of products within the MCC that may be impacted by the news.

At step 430, a third machine learning model may be used to determine a second product associated with the first small business merchant and correlated with the first product. The second product may be one of the plurality of products within the MCC that may be impacted by the news. The second product may not be one of the plurality of products within the MCC that may be impacted by the news. The third machine learning model may determine the second product based on the output of the second machine learning model—namely the first product that may be impacted by the news and previous transaction records on recurring purchases. For example, the third machine learning mode may determine that shortages of lumber may lead to shortages of other goods, such as hardwood flooring and/or cabinets. The third machine learning mode may determine that the small business builder may frequently make recurring purchases of lumber and hardwood flooring together. The merchant prediction servers may send alerts to the small business builder for the predicted shortages of the lumber and hardwood flooring.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
retrieving, by a first device and using a scraping algorithm, news associated with a geographic area;
parsing the news to identify keywords, wherein the keywords comprise at least one of topic keywords or volatility triggering keywords;
determining, based on one or more keywords, one or more industries associated with the geographic area that will be impacted by the news;
retrieving enterprise merchant intelligence information associated with one or more small business merchants, wherein the enterprise merchant intelligence information comprises a merchant category for each of the one or more small business merchants;
determining, using a first machine learning model and based on a first industry of the one or more industries matching a first merchant category, a first small business merchant that will be impacted by the news;
determining, using a second machine learning model, one or more products associated with the first small business merchant that will be impacted by the news; and
sending, to the first small business merchant on a second device, an alert indicating shortages of the one or more products.

2. The computer-implemented method of claim 1, further comprising:
prior to determining the first small business merchant, training the first machine learning model to identify small business merchants associated with the first merchant category.

3. The computer-implemented method of claim 1, further comprising:
prior to determining the one or more products, training the second machine learning model using previous transaction records associated with recurrent purchases.

4. The computer-implemented method of claim 1, wherein determining the one or more products comprises:
analyzing historical transactions of the first small business merchant, wherein the historical transactions comprise one or more recurring purchases; and
determining the one or more products based on the one or more recurring purchases.

5. The computer-implemented method of claim 1, wherein parsing the news further comprises:
parsing the news using natural language processing (NLP).

6. The computer-implemented method of claim 1 wherein parsing the news further comprises:
extracting the news to a text format; and
analyzing the text format to determine the one or more keywords.

7. The computer-implemented method of claim 6, wherein further comprising:
determining the one or more keywords using term frequency-inverse document frequency (TFIDF) analysis.

8. The computer-implemented method of claim 1, further comprising:
analyzing credit history of the first small business merchant;
comparing a current credit limit to a historic credit limit; and
increasing the current credit limit based on a prediction that the first small business merchant will be stockpiling the one or more products based on the alert.

9. The computer-implemented method of claim 1, further comprising:
analyzing spending history of the first small business merchant;
comparing current spending behavior with past spending behavior; and
adjusting a fraud logic based on a prediction that the first small business merchant will be stockpiling the one or more products based on the alert.

10. The computer-implemented method of claim 1, further comprising:
sending, to the first small business merchant, a recommendation to stockpile the one or more products.

11. The computer-implemented method of claim 1, wherein retrieving the news further comprises:
automatically retrieving the news from online public sources or a third party Application Programing Interface (API).

12. The computer-implemented method of claim 1, wherein determining the one or more product comprises:
determining, using the second machine learning model, a first product associated with the first small business merchant that will be impacted by the news;
determining, using the second machine learning model, a second product associated with the first small business merchant and correlated with the first product that will be impacted by the news; and
wherein the alert comprises indicating the shortage of the first product and the second product.

13. A computing device comprising:
an enterprise merchant intelligence information database;
one or more processors; and
memory storing instructions that, when executed by the one or more processors, cause the computing device to:
retrieve, using a scraping algorithm, news associated with a geographic area;
parse the news to identify keywords, wherein the keywords comprise at least one of topic keywords or volatility triggering keywords;
determine, based on one or more keywords, one or more industries associated with the geographic area that will be impacted by the news;
retrieve enterprise merchant intelligence information associated with one or more small business merchants, wherein the enterprise merchant intelligence information comprises a merchant category for each of the one or more small business merchants;
train a first machine learning model to identify the one or more keywords associated with a first merchant category;
determine, using the first machine learning model and based on a first industry of the one or more industries matching the first merchant category, a first small business merchant that will be impacted by the news;
train a second machine learning model using previous transaction records on recurrent purchases;
determine, using the second machine learning model, one or more products associated with the first small business merchant that will be impacted by the news; and
send, to the first small business merchant, an alert indicating shortages of the one or more products.

14. The computing device of claim 13, wherein the instructions cause the computing device to:
analyze historical transactions of the first small business merchant, wherein the historical transactions comprise one or more recurring purchases; and
determine the one or more products based on the one or more recurring purchases.

15. The computing device of claim 13, wherein the instructions cause the computing device to:
parse the news using natural language processing (NLP).

16. The computing device of claim 13, wherein the instructions cause the computing device to:
extract the news to a text format; and
analyze the text format to determine the one or more keywords.

17. The computing device of claim 16, wherein the instructions cause the computing device to:
determine the one or more keywords using term frequency-inverse document frequency (TFIDF) analysis.

18. The computing device of claim 13, wherein the instructions cause the computing device to:
automatically retrieve the news from online public sources or a third party Application Programing Interface (API).

19. One or more non-transitory media storing instructions that, when executed by one or more processors, cause the one or more processors to perform steps comprising:
retrieving, using a scraping algorithm and in a first data format, news associated with a geographic area;
parsing the news to identify keywords, wherein the keywords comprise at least one of topic keywords or volatility triggering keywords;
converting the first data format to a common data format;
determining, based on one or more keywords, one or more industries associated with the geographic area that will be impacted by the news;
retrieving, in a second data format, enterprise merchant intelligence information associated with one or more small business merchants, wherein the enterprise merchant intelligence information comprises a merchant category for each of the one or more small business merchants;
converting the second data format to the common data format;
determining, using a first machine learning model and based on a first industry of the one or more industries matching a first merchant category, a first small business merchant that will be impacted by the news;
determining, using a second machine learning model, one or more products associated with the first small business merchant that will be impacted by the news; and
sending, to the first small business merchant, an alert indicating shortages of the one or more products.

20. The non-transitory media of claim 19, wherein the first data format comprises unstructured data format, and the second data format comprises a text format.
